(19) United States
(12) Patent Application Publication
(10) Pub. No.: US 2025/0112257 A1
(43) Pub. Date: Apr. 3, 2025

(54) FUEL CELL SYSTEM CAPABLE OF IMPROVING UTILIZATION OF MIXED FUEL

(71) Applicant: BLADE HYDROGEN GREEN TECHNOLOGY CO., LTD., TAINAN CITY (TW)

(72) Inventors: BO-CONG GONG, TAINAN CITY (TW); SHIN-WEI LIANG, TAINAN CITY (TW); CHENG-WEI HSUEH, TAINAN CITY (TW); CHUN-HAN LI, TAINAN CITY (TW)

(21) Appl. No.: 18/899,093

(22) Filed: Sep. 27, 2024

(30) Foreign Application Priority Data
Oct. 2, 2023 (TW) 112137727

(51) Int. Cl. H01M 8/0662; B01D 53/22; H01M 8/04089; H01M 8/04223; H01M 8/0444; H01M 8/04537; H01M 8/04746

(52) U.S. Cl. CPC H01M 8/0687; B01D 53/22; H01M 8/04097; H01M 8/04231; H01M 8/04447; H01M 8/04559; H01M 8/04753; H01M 8/04783; B01D 2053/221

(57) ABSTRACT

A fuel cell system capable of improving the utilization of a mixed fuel includes a fuel cell, having an anode input terminal, a cathode input terminal, an anode output terminal and a cathode output terminal; a selective separator, having an input end, a hydrogen output end, and an unused gas output end; a hydrogen pump; a purge valve; and a steam trap. The fuel cell system can improve the separation efficiency of a hydrogen gas and reduce the hydrogen concentration of an exhaust gas to less than 4 vol %.

### FIELD OF THE INVENTION

The present invention relates to a fuel cell system, and more particularly to a fuel cell system capable of improving the utilization of a mixed fuel.

### BACKGROUND OF THE INVENTION

Fuel cells are one of the most widely used energy sources. However, in conventional fuel cells, much hydrogen is wasted, which reduces the utilization of hydrogen. Besides, if the hydrogen concentration of an exhaust gas exceeds the standard, it will not meet the standard for emission into the atmosphere and there may be a safety risk.

Chinese Patent Publication No. CN218918965U discloses a fuel cell system capable of improving the utilization of a hydrogen gas. The system is connected to a fuel cell stack and includes an inlet pipeline and an outlet pipeline. The outlet pipeline is equipped with a gas-water separator, an exhaust control valve, a pressure sensor, a hydrogen membrane separator and a backflow control valve. The backflow control valve controls the flow of the gas to the inlet pipeline. A controllable bypass pipeline is provided between the gas-water separator and the inlet pipeline. The hydrogen discharged in the nitrogen discharge process is separated by the hydrogen membrane separator and is returned for recycling via the backflow control valve, which not only avoids the waste of hydrogen but also makes the hydrogen concentration of the exhaust gas meet the standard so that the exhaust gas can be directly discharged into the atmosphere.

However, in the above-mentioned patent, the gas and liquid are first separated by the gas-water separator, and then the hydrogen is separated by the hydrogen membrane separator. Due to the presence of more impurities in the gas entering the hydrogen membrane separator via the gas-water separator, the separation efficiency of the hydrogen membrane separator is poor. Besides, it needs to detect the accumulation of pressure using the pressure sensor. The procedure is relatively complicated.

### SUMMARY OF THE INVENTION

The primary object of the present invention is to provide a fuel cell system capable of improving the utilization of a mixed fuel. The fuel cell system comprises a fuel cell, a selective separator, a hydrogen pump, a purge valve, and a steam trap. The fuel cell has an anode input terminal, a cathode input terminal, an anode output terminal, and a cathode output terminal. The selective separator has an input end connected to the anode output terminal, a hydrogen output end, and an unused gas output end. The selective separator is one of a pressure swing adsorption (PSA) separator, a preferential oxidation (PROX) separator, a selective membrane separator, a metal hydride hydrogen storage separator and a cryogenic distillation separator. The hydrogen pump is connected to the hydrogen output end and the anode input terminal. The purge valve is connected to the unused gas output end. The steam trap is connected to the cathode output terminal. When in use, a mixed fuel is input to the anode input terminal and air is input to the cathode input terminal. The mixed fuel contains a hydrogen gas and a diluent. An input concentration of the hydrogen gas in the mixed fuel is between 2 vol % and 99 vol %. After the fuel cell reacts with the mixed fuel and the air, an anode gas containing the unused hydrogen gas and the diluent is output from the anode output terminal to the selective separator, and a cathode gas containing the unused air is output from the cathode output terminal to the steam trap. After the anode gas is input into the selective separator, the hydrogen pump generates a pressure difference to push the hydrogen gas in the anode gas from the hydrogen output end back to the anode input terminal via the hydrogen pump. The unused anode gas is output from the unused gas output end to the steam trap via the purge valve. After the cathode gas and the unused anode gas are input into the steam trap, an exhaust gas and water are generated.

Preferably, the fuel cell system further comprises a flow controller, a control unit, and a hydrogen analyzer. The flow controller is connected to the anode input terminal. The hydrogen analyzer is connected to the hydrogen output end. The control unit is in signal connection with the fuel cell, the hydrogen pump, the flow controller and the hydrogen analyzer. The mixed fuel is input to the anode input terminal via the flow controller. The control unit obtains the input concentration of the hydrogen gas through the flow controller, a stack voltage through the fuel cell, and a recovery concentration or a recovery flow rate of the hydrogen gas through the hydrogen analyzer. The control unit compares the stack voltage with a preset voltage range. If the stack voltage does not fall within the preset voltage range, the control unit controls the hydrogen pump to change the pressure difference according to the input concentration, the stack voltage, and the recovery concentration or the recovery flow rate.

Preferably, the fuel cell system further comprises a mixer connected to the anode input terminal. After the hydrogen gas and the diluent are input into the mixer, they are mixed into the mixed fuel by the mixer.

Preferably, the fuel cell system further comprises an auxiliary selective separator. The auxiliary selective separator has an auxiliary input end connected to the hydrogen pump. The hydrogen gas in the anode gas and the mixed fuel are input to the anode input terminal via the auxiliary selective separator. The auxiliary selective separator further has an auxiliary hydrogen output end connected to the anode input terminal and an auxiliary unused gas output end connected to the input end of the selective separator.

Preferably, the fuel cell system further comprises an electronic load or a power grid inverter electrically connected to the fuel cell. After the fuel cell reacts, electricity is transferred to the electronic load or the power grid inverter.

Preferably, the fuel cell has an anode plate and a cathode plate adjacent to the anode plate. The anode plate has an anode flow channel. The cathode plate has a cathode flow channel. The anode input terminal and the anode output terminal communicate with two ends of the anode flow channel. The cathode input terminal and the cathode output terminal communicate with two ends of the cathode flow channel. An anode flow channel length is defined from the anode input terminal to the anode output terminal along the anode flow channel. A cathode flow channel length is defined from the cathode input terminal to the cathode output terminal along the cathode flow channel. The anode flow channel length and the cathode flow channel length are different.

Preferably, a hydrogen concentration of the exhaust gas is less than 4 vol %.

Preferably, the fuel cell is one of a proton exchange membrane fuel cell (PEMFC), an anion exchange membrane fuel cell (AEMFC) and a solid oxide fuel cell (SOFC).

Preferably, the diluent is an inert gas.

According to the above technical features, the present invention achieves the following effects:

1. The hydrogen gas is first separated from the anode gas by the selective separator, and then the unused anode gas is output to the steam trap via the purge valve, such that the separation efficiency of the hydrogen gas can be improved and the hydrogen concentration of the exhaust gas C can be reduced to less than 4 vol %.

2. The fuel cell system uses the selective separator and the hydrogen pump to generate a pressure difference. There is no need for the step of detecting the accumulation of pressure and extra energy. The hydrogen gas can be pumped back to the anode input terminal. Besides, the fuel utilization of the fuel cell system can be improved effectively in the presence of fuel starvation effect.

3. The control unit is configured for feedback control, it further ensures that the hydrogen concentration of the exhaust gas is reduced and that the target amount of the hydrogen gas to be consumed is met.

4. Using the mixed fuel containing the diluent and the hydrogen gas saves the cost of using pure hydrogen.

5. The auxiliary selective separator is configured for further improving the separation effect of the hydrogen gas while reducing the burden on the selective separator.

### BRIEF DESCRIPTION OF THE DRAWINGS

FIG. 1 is a block diagram of the fuel cell system according to a first embodiment of the present;

FIG. 2 is a planar schematic view of the anode plate according to the first embodiment of the present;

FIG. 3 is a planar schematic view of the cathode plate according to the first embodiment of the present;

FIG. 4 is a block diagram of the fuel cell system according to a second embodiment of the present;

FIG. 5 is a graph showing the relationship between voltage, hydrogen concentration and time of the 3 vol % mixed fuel according to the first embodiment of the present invention;

FIG. 6 is a graph showing the relationship between voltage, hydrogen concentration and time of the 40 vol % mixed fuel according to the first embodiment of the present invention;

FIG. 7 is a graph showing the relationship between voltage, hydrogen concentration and time of the 50 vol % mixed fuel according to the first embodiment of the present invention; and

FIG. 8 is a graph showing the relationship between voltage, hydrogen concentration and time of the 99 vol % mixed fuel according to the first embodiment of the present invention.

### DESCRIPTION OF THE PREFERRED EMBODIMENTS

Embodiments of the present invention will now be described, by way of example only, with reference to the accompanying drawings.

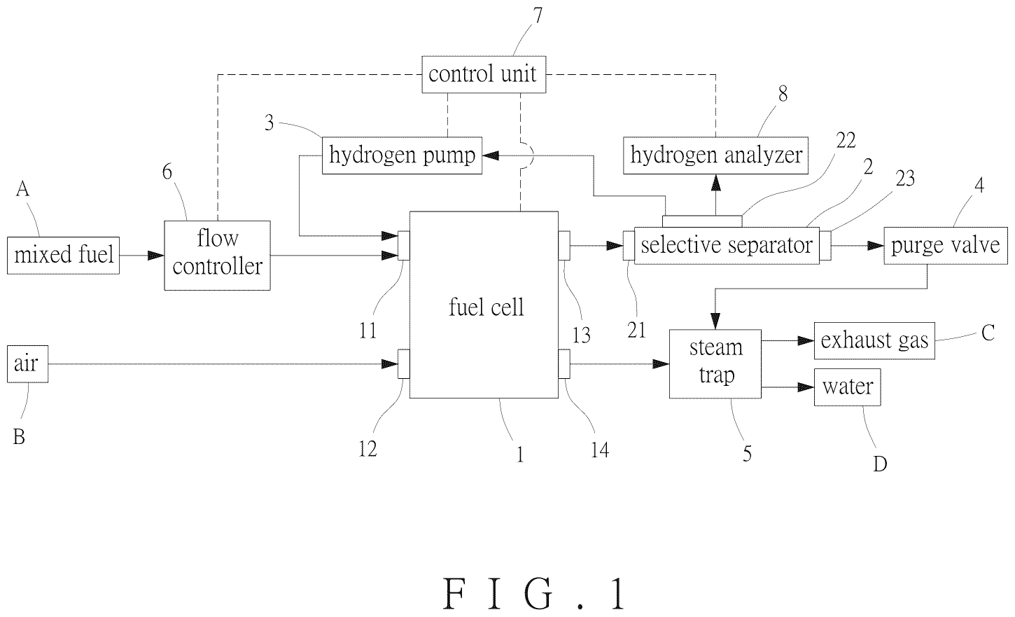

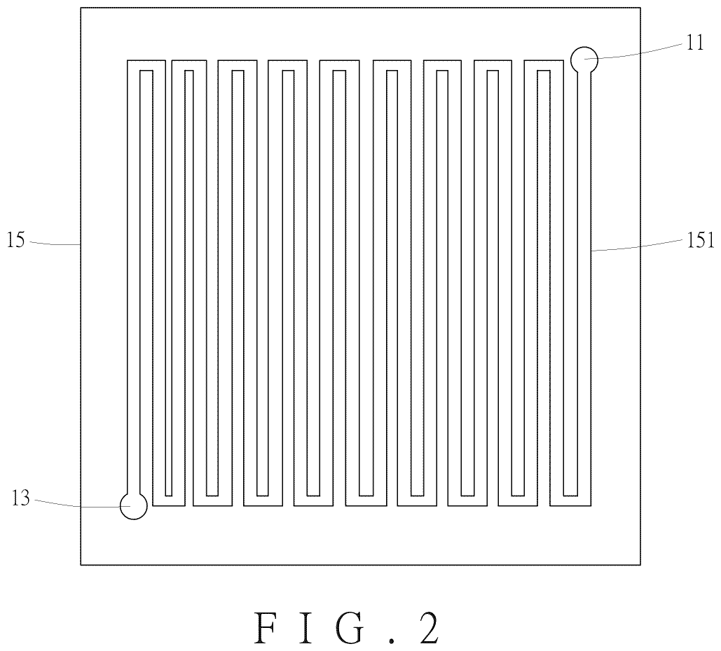

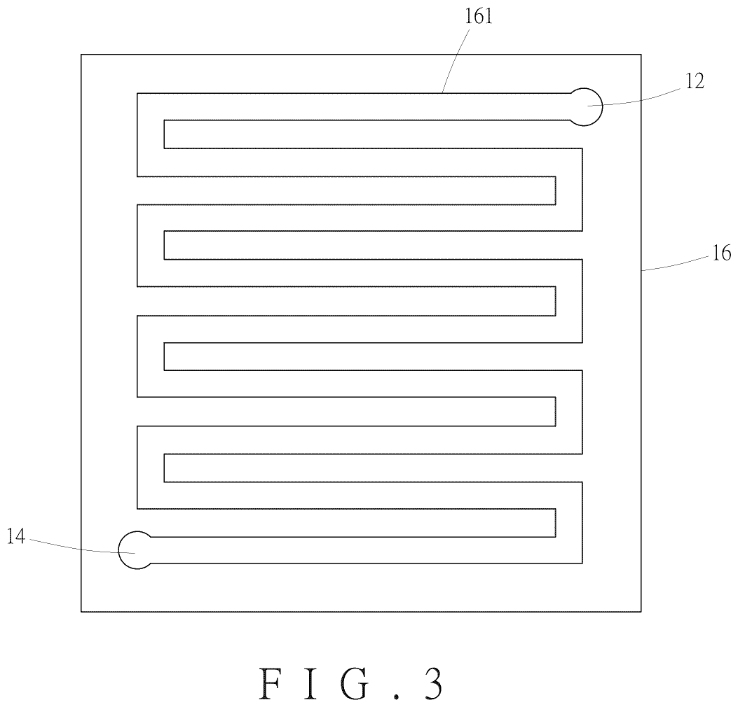

Referring to FIG. 1, FIG. 2 and FIG. 3, the present invention discloses a fuel cell system capable of improving the utilization of a mixed fuel. The fuel cell system according to a first embodiment of the present invention comprises a fuel cell 1, a selective separator 2, a hydrogen pump 3, a purge valve 4, a steam trap 5, a flow controller 6, a control unit 7, and a hydrogen analyzer 8.

The fuel cell 1 has an anode input terminal 11, a cathode input terminal 12, an anode output terminal 13, and a cathode output terminal 14. The fuel cell 1 is one of a proton exchange membrane fuel cell (PEMFC), an anion exchange membrane fuel cell (AEMFC) and a solid oxide fuel cell (SOFC). In actual implementation, a plurality of fuel cells 1 may be used to form a fuel cell stack.

In more detail, the fuel cell 1 has an anode plate 15 and a cathode plate 16 adjacent to the anode plate 15. The anode plate 15 has an anode flow channel 151. The cathode plate 16 has a cathode flow channel 161. The anode input terminal 11 and the anode output terminal 13 communicate with both ends of the anode flow channel 151. The cathode input terminal 12 and the cathode output terminal 14 communicate with both ends of the cathode flow channel 161.

An anode flow channel length is defined from the anode input terminal 11 to the anode output terminal 13 along the anode flow channel 151. A cathode flow channel length is defined from the cathode input terminal 12 to the cathode output terminal 14 along the cathode flow channel 161. The anode flow channel length and the cathode flow channel length are different.

The selective separator 2 has an input end 21 connected to the anode output terminal 13, a hydrogen output end 22, and an unused gas output end 23.

The selective separator 2 is one of a pressure swing adsorption (PSA) separator, a preferential oxidation (PROX) separator, a selective membrane separator, a metal hydride hydrogen storage separator and a cryogenic distillation separator. In this embodiment, the selective separator 2 is a selective membrane separator.

The hydrogen pump 3 is connected to the hydrogen output end 22 and the anode input terminal 11.

The purge valve 4 is connected to the unused gas output end 23.

The steam trap 5 is connected to the cathode output terminal 14.

The flow controller 6 is connected to the anode input terminal 11.

The control unit 7 is in signal connection with the fuel cell 1, the hydrogen pump 3, the flow controller 6 and the hydrogen analyzer 8.

The hydrogen analyzer 8 is connected to the hydrogen output end 22.

When the fuel cell system is in use, a mixed fuel A is input to the anode input terminal 11 via the flow controller 6 and air B is input to the cathode input terminal 12.

In actual implementation, a mixer (not shown) is connected to the anode input terminal 11. After a hydrogen gas and a diluent are input into the mixer through the respective flow controllers 6, they are mixed into the mixed fuel A by the mixer, thereby saving the cost of using pure hydrogen. In this embodiment, the input concentration of the hydrogen gas in the mixed fuel A is between 2 vol % and 99 vol %, and the diluent may be an inert gas such as nitrogen. The percentages of various concentrations described in this application refer to volume percentage concentrations.

The anode plate 15 and the cathode plate 16 are disposed inside the fuel cell 1. According to Graham's Law, the square root of the molecular weight of a gas is inversely proportional to the molecular velocity. Therefore, the mixed fuel A will initially separate the smaller molecular hydrogen and allow the hydrogen to react with the air B first.

After the fuel cell 1 reacts with the mixed fuel A and the air B, an anode gas containing the unused hydrogen gas and the diluent is output from the anode output terminal 13 to the selective separator 2, and a cathode gas containing the unused air B is output from the cathode output terminal 14 to the steam trap 5.

After the anode gas is input into the selective separator 2, the hydrogen pump 3 generates a pressure difference to push the hydrogen gas in the anode gas from the hydrogen output end 22 back to the anode input terminal 11 via the hydrogen pump 3. There is no need for the step of detecting the accumulation of pressure and extra energy. Besides, the fuel utilization of the fuel cell system can be improved effectively in the presence of fuel starvation effect. The unused anode gas is output from the unused gas output end 23 to the steam trap 5 via the purge valve 4.

At this time, the control unit 7 obtains the input concentration of the hydrogen gas through the flow controller 6, a stack voltage through the fuel cell 1, and a recovery concentration or a recovery flow rate of the hydrogen gas through the hydrogen analyzer 8 according to the type of the hydrogen analyzer 8.

The control unit 7 compares the stack voltage with a preset voltage range. If the stack voltage does not fall within the preset voltage range, the control unit 7 controls the hydrogen pump 3 to change the pressure difference according to the input concentration, the stack voltage, and the recovery concentration or the recovery flow rate. If the stack voltage falls within the preset voltage range, there is no need to change the differential pressure.

After the cathode gas and the unused anode gas are input into the steam trap 5, they are separated to generate an exhaust gas C and water D. The hydrogen concentration of the exhaust gas C is less than 4 vol %, which means less than 40,000 ppm.

In actual implementation, an electronic load or a power grid inverter (not shown) is electrically connected to the fuel cell 1. After the fuel cell 1 reacts, the electricity generated is transferred to the electronic load or the power grid inverter for subsequent use.

Since the hydrogen gas is first separated from the anode gas by the selective separator 2 and then the unused anode gas is output to the steam trap 5 via the purge valve 4, the separation efficiency of the hydrogen gas can be improved and the hydrogen concentration of the exhaust gas C can be reduced to less than 4 vol %.

The control unit 7 is configured for feedback control, it further ensures that the hydrogen concentration of the exhaust gas C is reduced and that the target amount of the hydrogen gas to be consumed is met.

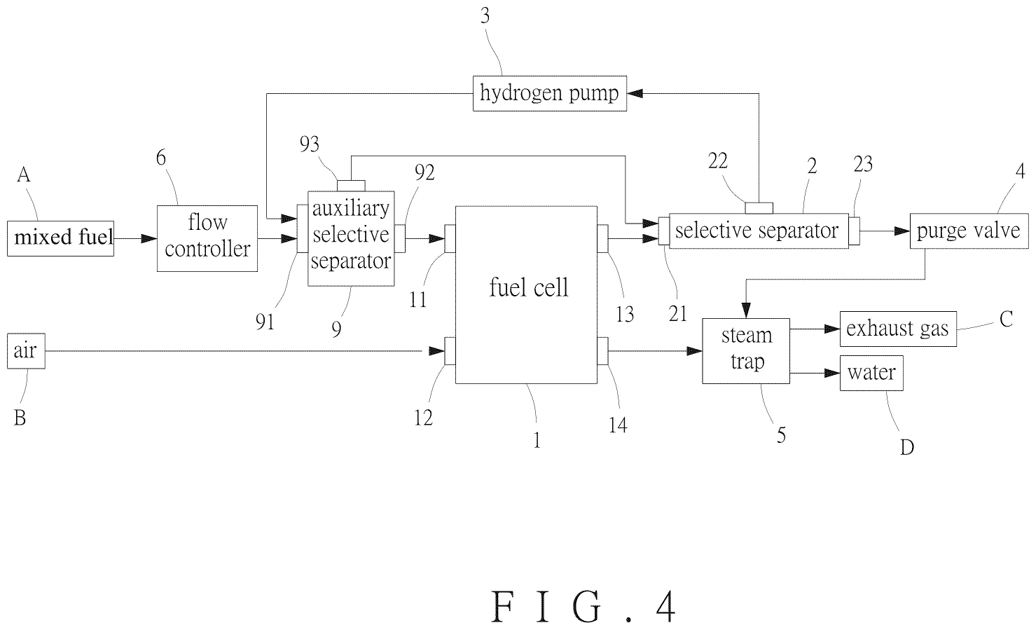

FIG. 4 illustrates a second embodiment of the present invention. The second embodiment is substantially similar to the first embodiment with the exception described below. The second embodiment further comprises an auxiliary selective separator 9. The other components and configurations are the same as those in the first embodiment, and will not be described in details.

The auxiliary selective separator 9 has an auxiliary input end 91 connected to the hydrogen pump 3. The hydrogen gas in the anode gas and the mixed fuel A are input to the anode input terminal 11 via the auxiliary selective separator 9. The auxiliary selective separator 9 further has an auxiliary hydrogen output end 92 connected to the anode input terminal 11 and an auxiliary unused gas output end 93 connected to the input end 21 of the selective separator 2.

In operation, the mixed fuel A is first separated by the auxiliary selective separator 9 to increase the concentration of the hydrogen gas input to the fuel cell 1. The reacted anode gas is first separated by the selective separator 2 and then flows back to the auxiliary selective separator 9 for a second separation. This reduces the burden of the selective separator 2 and improves the separation of hydrogen.

The non-hydrogen gas output from the auxiliary unused gas output end 93 flows into the selective separator 2 to be discharged from the unused gas output end 23.

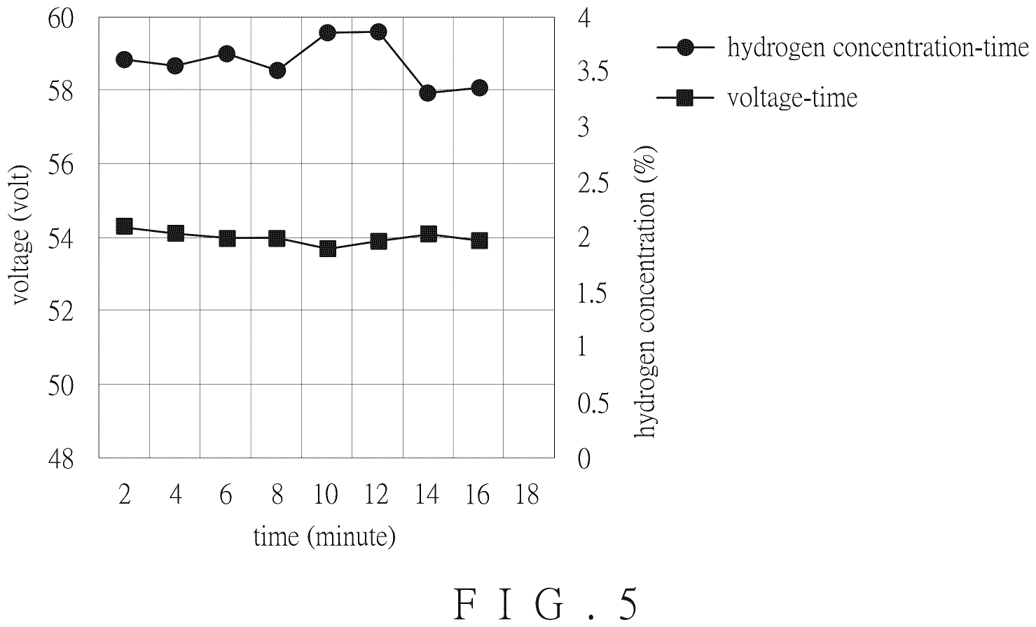

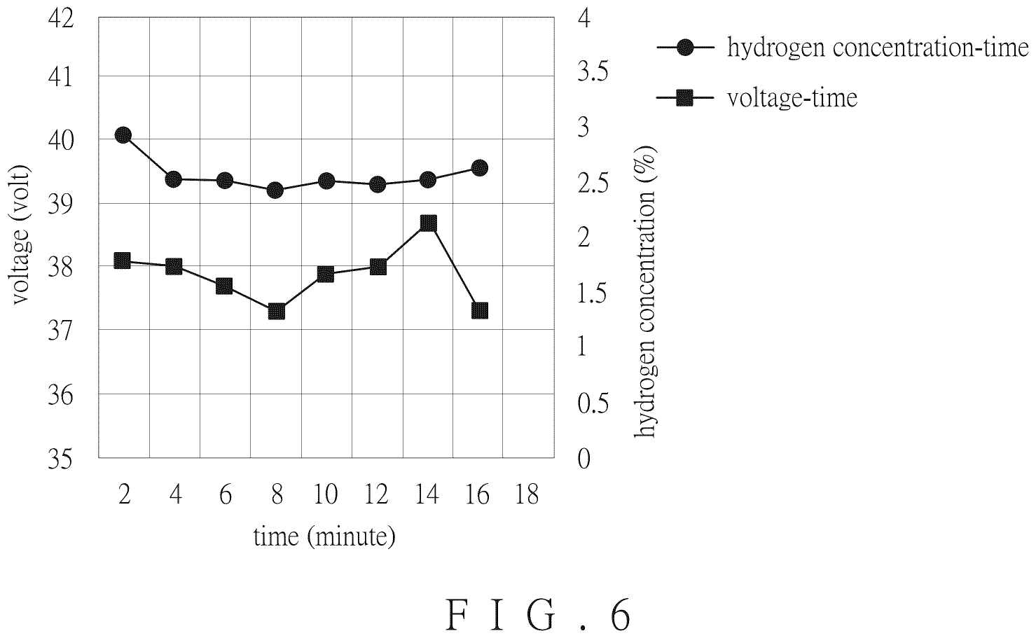

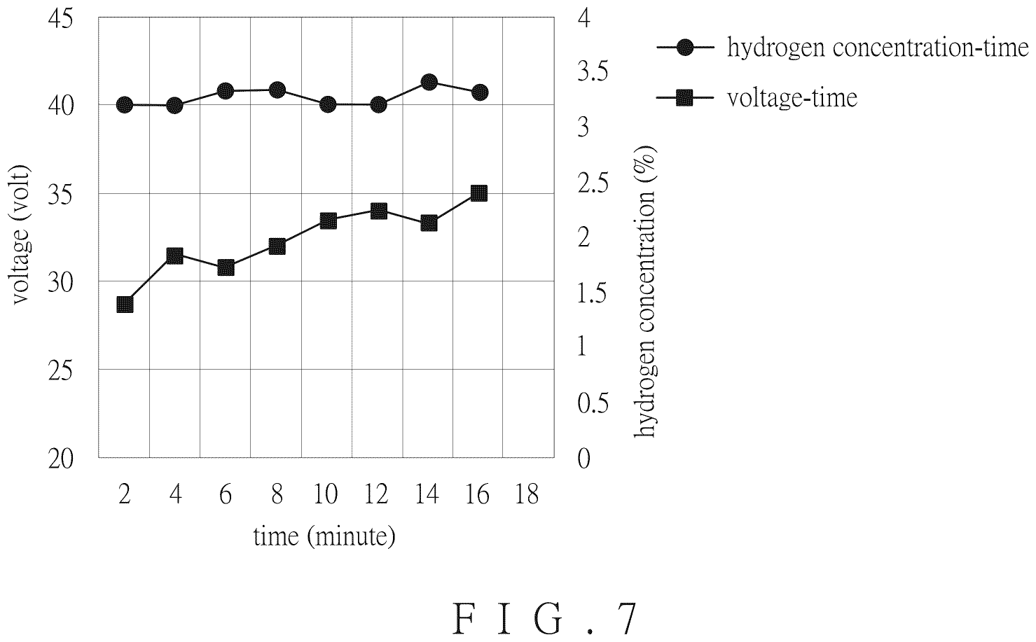

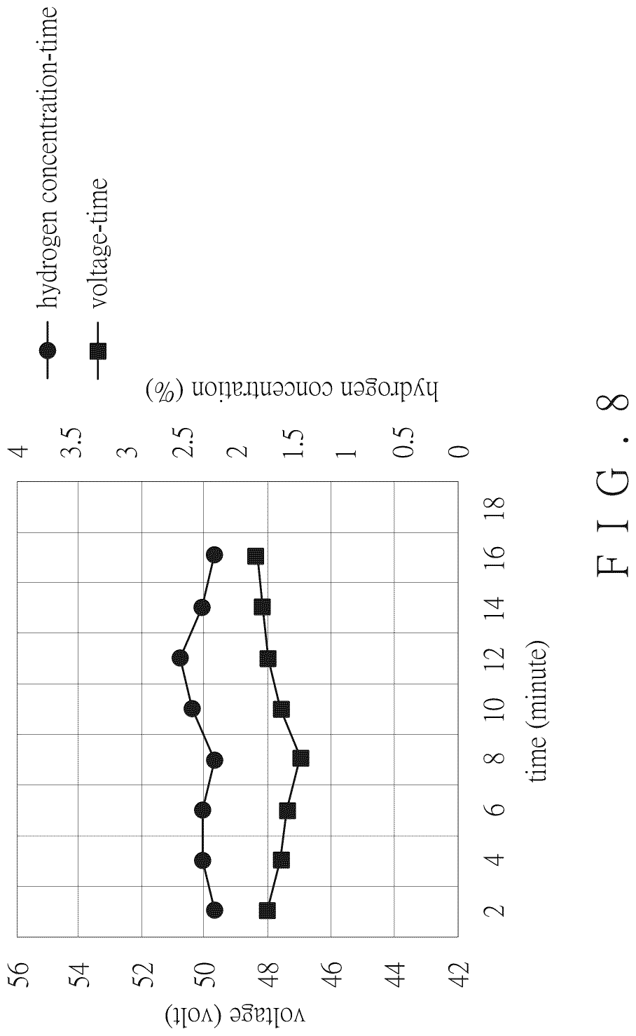

Please refer to FIG. 5 through FIG. 8, in conjunction with FIG. 1. The influence of different input concentrations of the hydrogen gas on the performance of power generation and the exhaust gas C was tested using the configurations of the first embodiment.

As shown in FIG. 5 through FIG. 8, the input concentrations of the hydrogen gas are 3 vol %, 40 vol %, 50 vol % and 99 vol %, respectively. The hydrogen gas is input into the fuel cell system with a generating power of 10 kilowatts. The hydrogen pump 3 is operated at maximum power for at least 15 minutes. After the fuel cell system is stable, the stack voltage and the hydrogen concentration of the exhaust gas C are recorded. The experimental data are shown in Table 1 below.

TABLE 1
experimental data

| | | load | average | generating | | |
|---|---|---|---|---|---|---|
| input | | current | voltage | power | fuel cell stack | |
| concentration | | (ampere) | (volt) | (kilowatt) | efficiency | |
| 3 | vol % | 3 | 54.4 | 0.162 | 26.8% | LHV |
| 40 | vol % | 128 | 37.2 | 4.76 | 36.2% | LHV |
| 50 | vol % | 200 | 34.7 | 6.94 | 35.2% | LHV |
| 90 | vol % | 209 | 48.4 | 10.1 | 50% | LHV |

As shown in Table 1 and FIGS. 5 to 8, the fuel cell system of the present invention indeed maintains good power generation under different conditions of input concentration and ensures that the hydrogen concentration of the exhaust gas C is less than 4 vol %.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A fuel cell system, comprising:
a fuel cell, having an anode input terminal, a cathode input terminal, an anode output terminal and a cathode output terminal;
a selective separator, having an input end connected to the anode output terminal, a hydrogen output end and an unused gas output end, wherein the selective separator is one of a pressure swing adsorption (PSA) separator, a preferential oxidation (PROX) separator, a selective membrane separator, a metal hydride hydrogen storage separator and a cryogenic distillation separator;
a hydrogen pump, connected to the hydrogen output end and the anode input terminal;
a purge valve, connected to the unused gas output end; and
a steam trap, connected to the cathode output terminal;
wherein when in use, a mixed fuel is input to the anode input terminal and air is input to the cathode input terminal, the mixed fuel contains a hydrogen gas and a diluent, and an input concentration of the hydrogen gas in the mixed fuel is between 2 vol % and 99 vol %;
wherein after the fuel cell reacts with the mixed fuel and the air, an anode gas containing the unused hydrogen gas and the diluent is output from the anode output terminal to the selective separator, and a cathode gas containing the unused air is output from the cathode output terminal to the steam trap;
wherein after the anode gas is input into the selective separator, the hydrogen pump generates a pressure difference to pump the hydrogen gas in the anode gas from the hydrogen output end back to the anode input terminal via the hydrogen pump, and the unused anode gas is output from the unused gas output end to the steam trap via the purge valve;
wherein after the cathode gas and the unused anode gas are input into the steam trap, an exhaust gas and water are generated.

2. The fuel cell system as claimed in claim 1, further comprising a flow controller, a control unit and a hydrogen analyzer, wherein the flow controller is connected to the anode input terminal, the hydrogen analyzer is connected to the hydrogen output end, the control unit is in signal connection with the fuel cell, the hydrogen pump, the flow controller and the hydrogen analyzer; the mixed fuel is input to the anode input terminal via the flow controller, the control unit obtains the input concentration of the hydrogen gas through the flow controller, a stack voltage through the fuel cell, and a recovery concentration or a recovery flow rate of the hydrogen gas through the hydrogen analyzer; the control unit compares the stack voltage with a preset voltage range, if the stack voltage does not fall within the preset voltage range, the control unit controls the hydrogen pump to change the pressure difference according to the input concentration, the stack voltage, and the recovery concentration or the recovery flow rate.

3. The fuel cell system as claimed in claim 1, further comprising a mixer connected to the anode input terminal, wherein after the hydrogen gas and the diluent are input into the mixer, they are mixed into the mixed fuel by the mixer.

4. The fuel cell system as claimed in claim 1, further comprising an auxiliary selective separator, wherein the auxiliary selective separator has an auxiliary input end connected to the hydrogen pump, the hydrogen gas in the anode gas and the mixed fuel are input to the anode input terminal via the auxiliary selective separator, and the auxiliary selective separator further has an auxiliary hydrogen output end connected to the anode input terminal and an auxiliary unused gas output end connected to the input end of the selective separator.

5. The fuel cell system as claimed in claim 1, further comprising an electronic load or a power grid inverter electrically connected to the fuel cell, wherein after the fuel cell reacts, electricity is transferred to the electronic load or the power grid inverter.

6. The fuel cell system as claimed in claim 1, wherein the fuel cell has an anode plate and a cathode plate adjacent to the anode plate, the anode plate has an anode flow channel, the cathode plate has a cathode flow channel, the anode input terminal and the anode output terminal communicate with two ends of the anode flow channel, the cathode input terminal and the cathode output terminal communicate with two ends of the cathode flow channel; an anode flow channel length is defined from the anode input terminal to the anode output terminal along the anode flow channel, a cathode flow channel length is defined from the cathode input terminal to the cathode output terminal along the cathode flow channel, and the anode flow channel length and the cathode flow channel length are different.

7. The fuel cell system as claimed in claim 1, wherein a hydrogen concentration of the exhaust gas is less than 4 vol %.

8. The fuel cell system as claimed in claim 1, wherein the fuel cell is one of a proton exchange membrane fuel cell (PEMFC), an anion exchange membrane fuel cell (AEMFC) and a solid oxide fuel cell (SOFC).

9. The fuel cell system as claimed in claim 1, wherein the diluent is an inert gas.
